(19) United States
(12) Patent Application Publication
(10) Pub. No.: US 2026/0174023 A1
(43) Pub. Date: Jun. 25, 2026

(54) AUTOMATED GARDEN CARE SYSTEM

(71) Applicant: Reese Webb, Plymouth, MA (US)

(72) Inventor: Reese Webb, Plymouth, MA (US)

(21) Appl. No.: 18/991,510

(22) Filed: Dec. 21, 2024

(51) Int. Cl. A01G 27/00

(52) U.S. Cl. CPC A01G 27/003; A01G 27/005; A01G 27/008

(57) ABSTRACT

The inventions related to an automated garden system. Systems, devices, and methods disclosed herein can be fully automated for remote monitoring and adjustment. The means for monitoring and control of a plurality of separate environmental parameters impacting plant growth, yield, fruiting, appearance, etc. These means allow gardeners and other users to monitor and care for their gardens from any location at great distances. The systems and methods of the present disclosure further enable users to adjust conditions within a defined environment to optimize plant health and growth that are tailored to the changing plant needs at different stages of plant development.

A clean copy of the amended Abstract is attached hereto as “Appendix A.” A marked-up copy showing the above changes is attached hereto as “Appendix B.” The amended Abstract contains no new matter.

### BACKGROUND

### Technical Field

The disclosures herein relate to systems, devices, and methods for automated garden care. Specifically, the present disclosures relate to automated garden systems that regulate the environmental and irrigation conditions in and around a garden space by implementing a plurality of sensors, a control unit, and regulation mechanisms.

### State of the Art

Since the inception of industrial farming techniques, global food production has exponentially increased. This is largely due to a sophisticated understanding of environmental conditions that materially affect plant growth and health and informed farmers having knowledge to optimally care for crops to maximize quality and yields. Furthermore, environmental conditions necessary for plant growth change throughout the plant life cycle. Accounting for these changing needs can further improve the health, output, and longevity of plants.

Understanding plant development from germination through senescence and the conditions that favorably influence plant growth distinguishes these stages. A “phenophase” is a biological stage in the life cycle of a plant or animal. Examples of plant phenophases include germination, growth, and flowering. The German Federal Biological Research Center for Agriculture and Forestry (“BBCH”) has developed a scale defining ten distinct phenological stages of plant development. Controlling the environmental parameters at each phenological stage provides an improvement on existing farming technologies.

Common to each phenophase is a need for proper light and moisture, which may be monitored and controlled using existing technology. For example, automatic systems typically regulate water and light levels for hydroponic indoor grow systems. Systems also exist to enable automatic crop irrigation at specified quantities and intervals on large-scale farms. However, these systems are lacking with respect to use in smaller gardens, greenhouses, and other settings. Further, existing systems are not equipped to monitor and control other environmental parameters impacting plant health such as air temperature, relative humidity, carbon dioxide concentration, air circulation, control of volatile vapors, and other parameters shown to affect plant health.

Current systems are also problematic because they require the regular, physical human presence to adjust plant growth conditions. When a person is unavailable to consider and adjust growth conditions, the health of the farm or garden can suffer. This regularly happens when gardeners travel away from their plants for any number of business and personal reasons. Also, dependable personnel are expensive and may be difficult to find and retain. Therefore, there is a need to automate a garden control system that can be adjusted remotely to ensure the health of a garden without requiring the physical presence of a gardener or maintenance personnel.

Human factors can impact the health of a farm or garden. For example, human error can lead to overwatering or underwatering crops resulting in suboptimal growth or death of the plant. Additionally, human application of fertilizer throughout a garden can result in an uneven covering and patches receiving too much or too little fertilizer. Reducing manual human interaction can reduce garden maintenance errors and result in increased garden health and outputs.

For at least the foregoing issues, there exists a need for a system to monitor and regulate these and other environmental parameters for non-farm garden systems.

### BRIEF SUMMARY

Disclosed herein are embodiments of an automated gardening system. The automated gardening system comprises a plant container disposed in an environment; a parameter control having a sensor, an electronics module functionally coupled to the sensor, and an effector disposed in the environment and functionally coupled to the electronics module, wherein the parameter control is configured to modulate a condition of the environment from the group of conditions consisting of a temperature, a relative humidity, a light level, a light spectrum, a moisture level, an odor, and a carbon dioxide concentration; wherein the condition of the environment is sensed by the sensor and changed by the effector; and a master controller communicatively coupled to the parameter control and having programmable logic controller, a memory, and a user interface.

In some embodiments, the master controller comprises a network switch. In some embodiments, the effector comprises an electrical relay. In some embodiments, the relay is a solid-state relay. In some embodiments, the plant container is a sub-irrigated planter.

In some embodiments, the parameter control is an irrigation subsystem comprising a feeder tank; a flow control device functionally coupled to the electronics module; a tube fluidly coupling the feeder tank to the plant container; and a moisture sensor disposed within the plant container and functionally coupled to the electronic module. In some embodiments, the irrigation control system comprises a pump configured to move the fluid through the plurality of tubes in response to a signal from the float switch.

Disclosed is an automated gardening system comprising a feeder tank; a plant container disposed in an environment and having zones therein including a soil area, a water area containing water, and an air space disposed between the soil area and the water area; a tube fluidly interposed between the feeder tank and the plant container; a parameter control comprising a sensor, an effector, and an electronics module functionally coupled to the sensor and the effector, wherein the sensor is a fluid level sensor positioned in the water area, the effector is a valve mechanism disposed in the tube; wherein the parameter control is configured to modulate a fluid level within the water area; and a master controller communicatively coupled to the parameter control and having programmable logic controller, a memory, and a user interface.

In some embodiments, the fluid level sensor disposed within the water area comprises a top inner tube and a bottom outer tube coaxial with and at least partially overlapping the top inner tube; wherein the top inner tube comprises two diametrically opposed conductive probes, the bottom outer tube comprises two diametrically opposed conductive probes, and the top inner tube is moveably coupled to the bottom outer tube.

The foregoing and other features and advantages of the invention will be apparent to those of ordinary skill in the art from the following more particular description of the invention and the accompanying drawings.

### BRIEF DESCRIPTION OF THE DRAWINGS

Reference will now be made to exemplary embodiments, examples of which are illustrated in the accompanying drawings. Wherever possible, the same reference numbers will be used throughout the drawings to refer to the same or like parts. The drawings are not necessarily to scale.

FIG. 1 is a schematic view of an embodiment of an automated gardening system;

FIG. 2 is a schematic view of an embodiment of a gravity-fed irrigation subsystem;

FIG. 3 is a front view of an embodiment of a sub-irrigated plant container and soil moisture probe;

FIG. 4 is a schematic view of an embodiment of an electronics module; and

FIG. 5 is a diagram of steps of a method of controlling an automated gardening system.

### DETAILED DESCRIPTION

Various example embodiments of an automated gardening system are described in detail herein. Many environmental conditions affect plant growth and are controlled by the automated system. Note that section headings used herein are for organizational purposes only and are not to be construed as limiting the described subject matter.

In addition to soil moisture levels, the duration and spectrum of light exposure is significant. Increased light exposure extends the number of hours when a plant performs photosynthesis. During this process, a plant produces sugars, such as glucose and fructose. This is especially important for fruiting plants, where longer light exposure can increase fruit yield, quality, and sugar levels. Conversely, excessive light exposure can damage plant health by breaking down chlorophyll, leading to chlorosis, a disease where the leaves yellow and droop.

Further, conditions of the air surrounding the plant including temperature, relative humidity, carbon dioxide concentration, and air circulation affect plant growth. Even excess airborne pollutants, including ozone, volatile ketones and alcohols, and others present in the environment impact plant health. This is especially a concern in enclosed environments such as a greenhouse.

The systems disclosed herein are automated, may be incorporated into an indoor or an outdoor garden. Embodiments tiffed with wireless connectivity and an Internet gateway can be user-controlled from anywhere in the world having an Internet connection. A central controller; i.e., master controller utilizes readily available components, such as a PLC controller, Raspberry Pi, network switch, solid-state relays (both wired & wireless), one or more float switches, electro-mechanical valves such as ball valves, one or more water tanks, one or more water pumps, electrical moisture sensors, and a novel sub-irrigate planter (SIP) sensor. The overall functionality of the system is automated by algorithms of a software application stored on a memory and executed by a microprocessor within the master controller. The sensors are used to measure temperature, carbon dioxide, soil moisture, water levels, and relative humidity. The sensors and system may be configured to run as a 12 or 24-volt direct current-based system powered by a battery with solar and/or wind charging capabilities, or, in some cases, as a 120-volt system powered by a standard AC house outlet.

The software application is configured to allow the user to set up day/night time setpoints through an augmented user interface (i.e., smartphone, laptop, tablet) to regulate environmental parameters and water delivery (irrigation) to the system. The number of moisture sensors/SIP sensors and ball valves used depends on the type & size of system purchased. In some embodiments, a single master controller regulates more than one separate garden system in the same or separate local environments. The system can be gravity fed or forced-flow and may include built-in controls to prevent flooding.

### Definitions

As used herein, the singular form of a noun includes the plural unless otherwise stated. As used herein, “or” includes “and” unless otherwise stated. As used herein, “including” and alternative forms such as “includes” and “included” is not limiting. Any range disclosed herein will be understood to include the endpoints and all values between the endpoints.

As used herein, “automated gardening system” means a garden having one or more environmental controls that are automated to monitor and change a parameter of a closed-system environment. The automated gardening system regulates growing conditions through the parameter controls, referred to as subsystems in some examples. “Subsystem” as used herein broadly means a complicated parameter control having multiple elements beyond a single parameter sensor, electronics module, communication links for transmitting a sensor and an effector signal, and an effector device. A non-limiting example of a subsystem is an irrigation system having a soil moisture sensor, a float switch positioned in a plant container, a float switch positions in a fluid reservoir, a pump, etc. In some embodiments, the automated gardening system has multiple sub-systems that monitor and adjust a specific parameter or condition of the enclosed local plant growth environment. The user can input acceptable value ranges for the various environmental parameters and input these values through a user interface on a master controller that monitors and directs functionality of the one ore more parameter controls or subsystems. As used herein, “automated garden system” and “automated gardening system” have the same meaning and can be used interchangeably.

As used herein, “soil” means a root-supporting and moisture retaining medium in which a plant is planted. Soil can be traditional potting soil or other commercially available product. Soil may comprise a single material, or a combination of materials known in the art for supporting plant growth. For example, soil may comprise organic materials, air, water, gases, and living organisms. To suit the needs of different plant types, soil may be enhanced with the addition of elements like compost, peat moss, clay, perlite, tree bark, carbonized materials such as biochar, vermiculite, limestone, and sand. As used herein, soil is also understood to include any media wherein a plant can be planted. Such media include a liquid or a colloidal gel wherein various nutrients are dissolved or suspended.

The several drawing figures discussed below are used to set forth additional details about these and other embodiments.

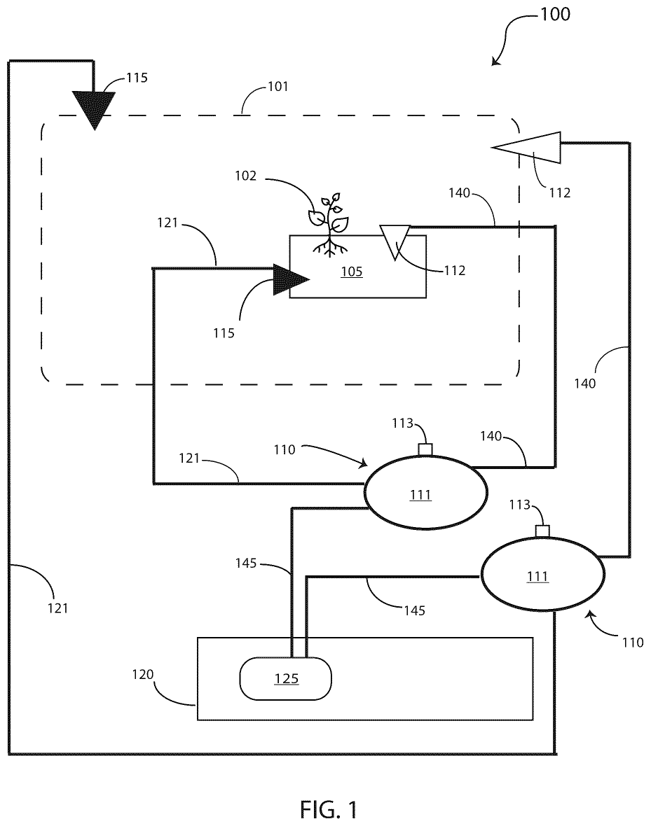

FIG. 1 is a schematic view of an embodiment of an automated garden system. FIG. 1 shows system 100 with its components. In some embodiments, automated garden system 100 comprises an environment 101 wherein various environmental parameters affecting plant growth are present. Environment 101 is defined as a portion or an entirety of a defined space, such as a greenhouse, an outdoor garden space, an indoor garden space, or the like. Environment 101 includes that space adjacent/immediately proximate to and surrounding to all physical parts of a plant. “Physical parts of the plant” includes roots, stems, leaves, etc.

As shown in FIG. 1, a plant container 105 is disposed within environment 101. In various embodiments, plant container 105 comprises a pot, a tray, a shelf, a planter, a polybag, a plug, a peat pellet, an aeroponics tower, or the like. Container 105 may be commercially available pots made from ceramic, plastic, metal, wooden materials or other material suitable for containing a planting medium or water. In some embodiments, planter 101 comprises a sub-irrigated planter. A plant 102 is grown in container 105. In some embodiments, container 105 contains one plant 102. In some embodiments, container 105 is dimensioned and otherwise configured to contain a plurality of plants 102. Plant 102 may be any number of plant types and species capable of growing in an indoor or outdoor environment. For example, plant 102 may be a fruit, a vegetable, an herb, or a fungi. In some embodiments, plant 102 is a seedling, a sapling, or a tree. Container 105 additionally contains and restrains a material necessary to support the plant roots, such as soil, compost, peat moss, clay, perlite, or the like. In some embodiments, container 105 contains a liquid or a root-supporting gel wherein various nutrients are dissolved or suspended.

FIG. 1 also shows a parameter control 110 configured to monitor and regulate a condition of environment 101. In some embodiments, parameter control 110 comprises an electronics module 111 having a printed circuit board 114 (not pictured), a sensor 112 that communicates a sensor signal 140 to electronics module 111, a switch 113 activated or de-activated by electronics module 111 in response to sensor signal 140, and an effector 115 that receives an effector signal 121 from electronics module 111. Some non-limiting examples of the condition of environment 101 monitored and regulated by parameter control 110 include soil moisture content, relative humidity, soil or air temperature, carbon dioxide concentration, and others. FIG. 1 shows two (2) parameter controls 110. In some embodiments, system 100 comprises one, two, three, or any plurality of separate parameter controls 110. Each parameter control 110 monitors and regulates a different condition of environment 101, in some embodiments of system 100.

Electronics module 111 is configured to (1) receive a sensor signal 140 generated by sensor 112; (2) determine whether signal 140 is an acceptable value, i.e., within a preset range; and (3) transmit an effector signal 121 to an effector 115.

In some embodiments, sensor 112 is a voltage sensor whose voltage changes according to a changing condition of environment 101. In some embodiments, sensor 112 is a resistive voltage sensor, a capacitive voltage sensor, or an inductive voltage sensor. In some embodiments, sensor 112 is a digital or analog time-keeping device, i.e., a clock. Clocks are used, for example, in cases where effector 115 is a light that is programmed to be active during hours of the day ideal for the particular phenological developmental stage of plant 102. Data transmitted as signal 140 from sensor 112 determines a state of electronics module 111. To affect the state of electronics module 111, switch 113 is functionally coupled to sensor 112.

In some embodiments, module 111 is configured to modulate a moisture level within environment 101, such as a soil moisture level or an ambient air moisture (relative humidity). In some embodiments, sensor 112 is a conventional soil moisture sensor. Functionally, as the moisture level of soil or other plant-supporting substrate held within container 105 drops, an electrical resistance of sensor 112 increases, changing conductivity to cause a corresponding voltage to increase. As the voltage increases to a level set by an operator of system 100, module 111 activates switch 113 to activate an irrigation subsystem (not shown) through switch 113, causing water to be added to plant container 105. As the water content increases, the resistance of sensor 112 will decrease and the voltage correspondingly decreases. When a second voltage setpoint is reached, module 111 causes deactivation of switch 113. This stops the flow of water by irrigation subsystem 150 and stops delivering water to plant container 105.

In some embodiments, module 111 is configured to modulate a temperature within environment 101, such as an air temperature or a soil temperature, for example. In these embodiments, effector 115 is a heater and sensor 112 is a temperature sensor. Temperature sensor 112 comprises a negative temperature coefficient thermistor, a resistance temperature detector, a thermocouple, or a semiconductor-based sensor. The electrical output of sensor 112 changes as the air or soil temperature within environment 101 changes. When sensor 112 detects a temperature drop below a preset level, electronics module 111 activates switch 113 to activate heater 115 until the temperature increases to a preset level.

Effector 115 is an effector device configured to change a parameter of environment 101 such as a heater, an air conditioner, a humidifier, a dehumidifier, an illumination source such as a light or lamp, an irrigation subsystem, a ventilator, a coal fan, or a carbon dioxide modifier. Effector 115 may be a single device or a system of devices acting together to change the parameter in response to an effector signal 121 received from module 111. In some embodiments, a single module 111 generates two or more effector signals 121 to a corresponding two or more effector devices 115. In some embodiments, electronics module 111 comprises a “state” that changes in response to sensor signal 140. For example, the state of electronics module 111 may be active, non-active, or may change in degree or level.

A user may separately dictate setpoints within any parameter control 110 of automated system 100 to maintain the parameter specific to control 110 within a certain range. For example, air temperature setpoints may be defined to maintain the air temperature of environment 101 at 15, 16, 17, 18, 19, 20, 21, 22, 23, 24, 25, 26, 27, 28, 29, 30, 31, 32, 33, 34, or 35 degrees Celsius (° C.). These values may be used to define discrete temperatures, such as 22, 24, or 25° C. Alternatively, these values may be used to define a range of temperatures such as 24-26° C. In some embodiments, such parameter set points can be programmed to change throughout the day according to the needs of plant(s) 102. For example, the temperature set points may be set to 25-30° C. during the day while the plant is exposed to light and set to 20-25° C. during nighttime hours. Different temperature set points may be programmed for different types of plants 102 disposed within environment 101.

Additionally, parameter control 110 may comprise multiple effectors 115 coupled to a single module 111. For example, to control air temperature as described above, electronics module 111 may comprise a heater and an air conditioner (refrigeration means) within a single device. This may be helpful, for example, in temperate climates where the outside air temperature varies greatly throughout the year and maintaining a constant temperature setpoint or setpoint range requires heating in the winter and air conditioning in the summer.

To optimize plant health and development, automated garden system 100 has two, three, or any plurality of parameter controls 110 to control multiple environmental conditions within environment 101, in some embodiments. An example embodiment of automated garden system 100 having seven (7) parameter controls 110 is now discussed in detail. The designations of “first,” second,” “third,” etc. parameter controls 110 as controlling a specific parameter for this example embodiment of system 100 and specific to this example and intended to be limiting

A first parameter control 110 monitors the soil moisture level and control the irrigation subsystem as described above. Qualities or conditions of the air surrounding plant 102 such as air temperature, relative humidity, air circulation, volatile pollutants, and carbon dioxide concentration affect plant growth. Plants can freeze and fail if temperatures fall below acceptable ranges. Also, temperatures that are too high for a plant can burn leaves, shrivel fruits, and cause plant death. Thus, a second parameter control 110 controls ambient air temperature as described above. A third parameter control 110 controls relative humidity within environment 101 to a humidity setpoint value. In some embodiments, parameter control 110 uses a relative humidity sensor 112 and effector 115, such as a humidifier, to maintain the relative humidity within environment 101 to a setpoint of 30, 35, 40, 45, 50, 55, 60, 65, 70, 75, 80, 85, 90, 95% or more relative humidity. These values may be used to define discrete relative humidity values, such as 80% relative humidity, or they may be used to define a range of humidity values, such as 70-90% relative humidity, for example.

Light spectrum and duration of light exposure contribute to optimizing plant health. Therefore, a fourth parameter control 110 controls the timing of fifth effector 115, such as a light system and emission spectra, within environment 100, in some embodiments. The fourth parameter control 110 controls the hours during the day during which the light system is active. For example, a user may program fourth parameter control 110 to activate the light system from 8 AM to 8 PM, and to deactivate the light system from 8 PM to 8 AM for each 24-hour cycle.

Different plants flourish under different light spectra at different phenological development phases. Therefore, a fifth parameter control 110 controls the light spectrum emitted by the light system 115 within environment 100, in some embodiments. For example, a user may program fifth parameter control 110 to emit 400-500 nanometer (nm) blue light during the seedling stage of plant development. This spectrum of light promotes a strong root and stem system. In another example, programming fifth parameter control 110 to emit 600-700 nm red light during the flowing stage enhances the development of flowers and fruits. For fruiting plants, 700-800 nm near infrared light may accelerate the ripening process once the fruits develop. Programming a fifth parameter control 110 to optimize light spectrum at various plant development stages in these and some other example embodiments of system 100 can significantly increase plant health and yield.

A sixth parameter control 110 controls the air circulation and volatile organic presence within environment 100, in some embodiments. In some embodiments, sixth parameter control 110 controls the timing, airflow velocity, and other settings of a sixth effector 115, in the form of a ventilation system affecting environment 101. For example, sixth parameter control 110 may control the time and duration the ventilation system is active in each 24-hour day along with the speed of the air circulation produced by the ventilation system. For example, a user may program sixth parameter control 110 to mimic natural wind conditions and activate the ventilation system for a set duration, such as from 1 μm to 4 PM, during each 24-hour cycle. Further, sixth parameter control 110 may maintain a constant air circulation speed throughout the day or vary the air circulation speed as programmed by the user to best suit plant development.

Volatile air pollutants, such as ozone, ketone, or alcohol vapors present around a plant affect plant output and quality. These are a particular concern within an enclosed environment 101 such as a greenhouse. Therefore, seventh parameter control 110 may activate a seventh effector 115, in the form of an adsorbent system, upon detection of certain pollutants within environment 101, in some embodiments. When the concentration of one or more monitored pollutants reaches a maximum allowable threshold, seventh parameter control 110 deactivates the adsorbent system. In some embodiments, the adsorbent system is configured to blow ambient air from environment 101 over a bed of an adsorbent material, such as activated charcoal, for example.

A carbon dioxide concentration of the air surrounding a plant has significant impacts on plant health. Atmospheric carbon dioxide concentration is about 400 parts per million (ppm). The carbon dioxide concentration of air surrounding a plant below this level, for example, at 150 ppm, reduces plant photosynthesis and growth. At 100 ppm, for most plants photosynthesis stops completely. Many plants thrive under increased ambient carbon dioxide levels. For example, a carbon dioxide concentration of 800 ppm increases the rate of photosynthesis and thus increases the rate of plant growth. However, too much carbon dioxide in the ambient air such as concentrations of 2000 ppm or higher, becomes toxic to plants, resulting in the closing of the plant stomata and plant damage. Thus, to enable a user to measure and adjust carbon dioxide levels, in some embodiments, system 100 comprises an eight parameter control 110 that regulates a carbon dioxide concentration within environment 101. Eighth parameter control 110 may incorporate various devices to adjust carbon dioxide concentrations. For example, eighth parameter control 110 may comprise a carbon dioxide sensor 112 to measure ambient carbon dioxide concentrations. This sensor may be functionally coupled to an eighth effector 115, in the form of a carbon dioxide modulator. In some embodiments, the carbon dioxide modulator is a carbon dioxide generator, a dry ice distribution system, or a chemical reactor that combines materials such as baking soda and acetic acid to emit carbon dioxide into system 100 until it reaches a preset range of carbon dioxide concentration within environment 101, for example.

Other parameter controls 110 may be incorporated by system 100. For example, parameter controls that regulate additional ambient conditions of environment 101, such as oxygen concentration, particulate concentration, sound stimuli, and others. In some embodiments, control 110 is a monitoring, locking, or security system configured to detect additional conditions of environment 101, such as carbon monoxide levels and/or motion detection. Such additional controls 110 are coupled to additional effectors 115 and functions as an alarm system.

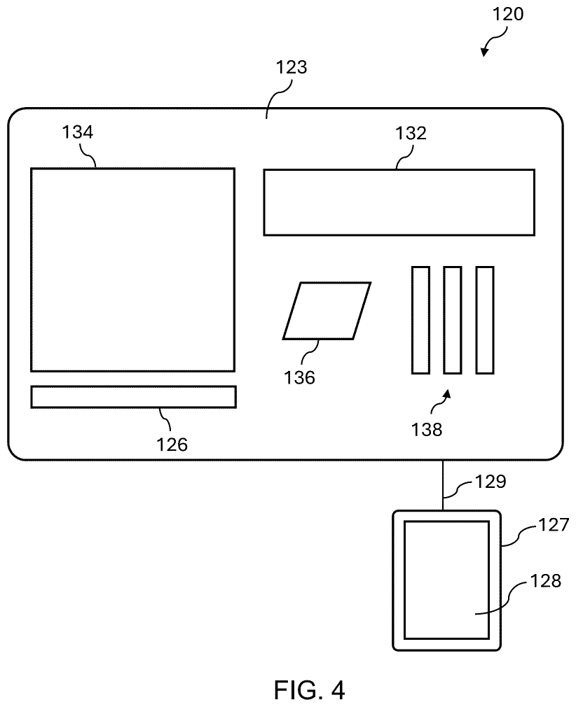

FIG. 1, also shows a master controller 120 communicatively coupled to parameter control 110. Each parameter control 110 is electronically connected to master controller 120 via input/output communication lines 145. In some embodiments, communication lines 14r are electrical wires. In some embodiments, communication lines 140 are wireless “line,” such as Bluetooth or WiFi, for example. In some embodiments, master controller 120 comprises a user interface 127 having a display 128, a memory 126, and a programmable logic controller 132. Master controller 120 is described in further detail below in reference to FIG. 4.

Automated garden system 100 further comprises communicative coupling means 140. In some embodiments, communicative coupling means 140 comprises electrically conductive wire, plugs, pins, connectors and related equipment widely used in the electronic arts to accommodate different input and output configurations of the electronic elements comprising automated garden system 100. In some embodiments, communicative coupling means 140 enable electronic elements within environment 100 to communicate in a wireless configuration. Communicative coupling means 145 connect master controller(s) 120 to one or more parameter controls 110 through electronics module(s) 111, as shown in FIG. 1, for example.

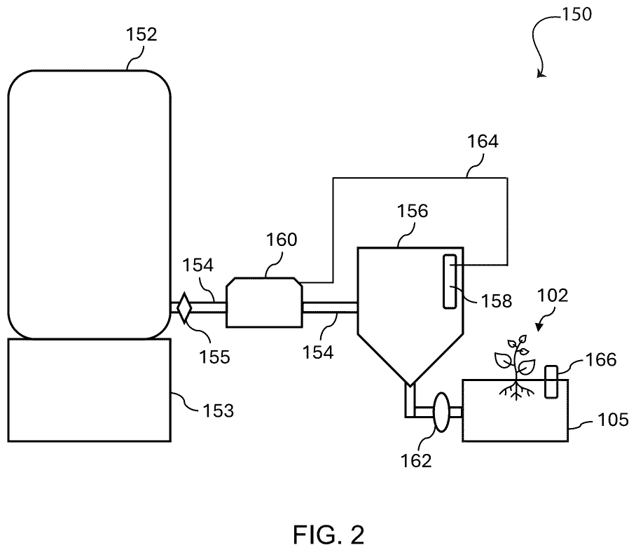

FIG. 2 is a schematic view of an embodiment of an irrigation subsystem. FIG. 2, shows an irrigation subsystem 150 of automated garden system 100. Irrigation subsystem 150 is one example of a subsystem-type of parameter control 110 as defined and described herein above. A plurality of tubes 154 fluidly couple tanks, reservoirs, plant containers, and pumps, and other fluid handling elements within system 100. Tube 100 are formed from metal such as copper or synthetic polymer such as polyvinyl chloride, or other material used in a conventional water plumbing system. In some embodiments, irrigation subsystem 150 comprises a feeder tank 152 having an interior volume configured to contain water or other fluid, a plurality of tubes 154, and a feeder tank base 153. In some embodiments, feeder tank 152 is raised in elevation to a level higher than container 105 and supported by feeder tank base 153. A outlet may be positioned near the bottom of the tank 152, in some embodiments, through which water exits the tank. Tube 154 coupled to the outlet of feeder tank 152 enables transit of fluid from feeder tank 152 to and between other elements of subsystem 150. Feeder tank 152 may be a variety of sizes, such as a 4, 5, 6, 8, 10, 20, or 30 gallon tank, depending on the overall size and water needs of automated garden system 100. In some embodiments, tank 152 has a volume of greater than thirty (30) gallons.

In some embodiments, irrigation subsystem 150 further comprises a filter 155 and a fluid reservoir 156. According to some embodiments, filter 155 is disposed in different locations throughout subsystem 150. For example, filter 155 is disposed on top of feeder tank 152, in some embodiments. In this example, water is filtered as it enters feeder tank 152. In other embodiments, filter 155 is disposed between feeder tank 152 and fluid reservoir 156. Specifically, one end of a tube 154 is coupled to an outlet of feeder tank 152 and a second end is coupled to an inlet port of filter 155. A second tube 154 couples a filter 155 outlet port to a fluid reservoir 156 inlet port. Thus, water is filtered as it moves between feeder tank 152 and fluid reservoir 156. Filter 155 is configured to filter particles or debris from water stored within irrigation subsystem 150 to prevent blockages or damage to subcomponents of subsystem 150.

In some embodiments, irrigation subsystem 150 comprises a fluid reservoir 156 having a float switch 158 disposed within fluid reservoir 156. Fluid reservoir 156 has an inlet for water to enter the reservoir and an outlet for water to exit the reservoir. In some embodiments, feeder tank 152 is connected to fluid reservoir 156 via a tube 154. Float switch 158 is in electronic communication with electronics module 110 of subsystem 150. In some embodiments, float switch 158 is in electronic communication with a pump 160 via a communication line 164. The user may program master controller 120 to monitor the water level within fluid reservoir 156 through subsystem 150. In some embodiments, float switch 158 is positioned toward the bottom of fluid reservoir 156 to transmit signal 140 to electronics module 110 when the water level within fluid reservoir 156 drops to a predetermined setpoint. Fluid reservoir 156 is formed as an inverted frustrum wherein float switch 158 is positioned to signal pump 160 when the volume of water contained within reservoir 156 is less than ten (10) percent of the total capacity of reservoir 156, in some embodiments, activating pump 160 to pump water from feeder tank 152 into fluid reservoir 156 until it reaches a predetermined maximum setpoint. Some embodiments of subsystem 150 are configured to receive a gravity feed of water or other fluid from feed tank 152 into fluid reservoir 150 and do not comprise pump 160. In these and some other embodiments, float switch 158 signals a valve (not shown) interposed between tank 152 and reservoir 156 causing the valve to open, allowing the fluid to flow by gravity from tank 152 into reservoir 156.

In some embodiments, irrigation subsystem 150 comprises flow control device 162 and plant container 105. In some embodiments, a tube 154 from the plurality of tubes fluidly couples the at least one fluid reservoir 156 to plant container 105. Flow control device 162 is disposed between fluid reservoir 156 and plant container 105 to engage or disengage water flow between them. In some embodiments, flow control device 162 is configured to adjust the flow rate of water moving from fluid reservoir 156 to plant container 105. In some embodiments, flow control device 162 comprises a ball valve. In some embodiments, flow control device 162 is an automated, magnetically controlled ball valve programmable to change from a closed position to an open position at predetermined moisture level setpoints detected by sensor 112 disposed at tank 105.

In some embodiments, irrigation subsystem 150 comprises a moisture probe 166 disposed within plant container 105. Moisture probe 166 is an example of a specific type of sensor 112. Moisture probe 166 can be a custom or commercially available soil moisture sensor that measures water content of soil or other substrates within plant container 105. For example, soil moisture probe 166 is a conventional 24-volt (direct current) moisture sensor, in some embodiments. As described herein, the moisture level of the soil within plant container 105 changes electrical resistance of the soil correspondingly changing voltage read by probe 166. At a predetermined setpoint, subsystem 150 allows water (or other fluid) to flow from reservoir 156 to container 105. This predetermined setpoint can activate flow for a set period of time, or until the reading of soil moisture probe 166 changes to indicate enough water has entered plant container 105.

As mentioned above, in some embodiments irrigation subsystem 150 utlizes gravity to move fluid between the elements of subsystem 150, wherein the outlet of feeder tank 152 is located at a higher elevation than other elements of irrigation subsystem 150 and the base of plant container 105 is located at the lowest elevation within irrigation subsystem 150. The benefits of a gravity-fed system include use of a force-gravity—that is constant, abundant, and free, wherein additional energy is not required to move fluid from feeder tank 152 to fluid reservoir 156 and on to plant container 105. This allows users to forgo pumps, reduces electricity costs, and also removes failure points from a non-gravity fed system.

In applications wherein gravity-fed systems are insufficient or otherwise not feasible, irrigation subsystem 150 comprises a pump 160. In some embodiments, pump 160 is a commercially available fluid pump powered by a 24-volt (direct current) electric motor. Pump 160 may comprise one or more pumps disposed in series throughout irrigation subsystem 150 to push water throughout the system. For example, a first pump 160 is disposed between feeder tank 152 and fluid reservoir 156. Fluid reservoir 156 is connected to first pump 160 by tube 154. When the water level within fluid reservoir 156 drops to a predetermined setpoint, system 100 is programed to activate power to first pump 160 moving water from feeder tank 152 to fluid reservoir 156. In some embodiments, a second pump 160 is disposed between fluid reservoir 156 and plant container 105. When the water content within plant container 105 drops to a predetermined setpoint, system 100 is programed to activate second pump 160 and move water from fluid reservoir 156 to plant container 105. In some embodiments, irrigation subsystem 150 comprises a combination of gravity-fed and pump-activated fluid circuits. For example, fluid movement between feeder tank 152 and fluid reservoir 156 may be gravity-fed and fluid movement between fluid reservoir 156 and plant container may be pump-activated.

Water or other fluids can be introduced to irrigation subsystem 150 in a variety of ways. In some embodiments, feeder tank 152 is connected to a municipal water line. In some embodiments, feeder tank 152 is connected to a rainwater collection system proximate automated garden system 100. Adding water to irrigation subsystem 150 may be controlled in a variety of ways. For example, a float pump within or a scale beneath feeder tank 152 may signal the addition of water to the tank.

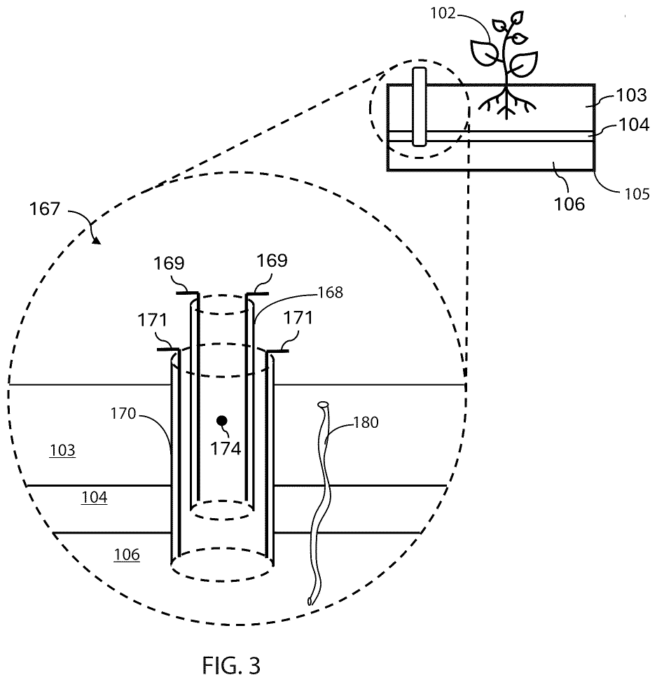

Overwatering plants can oversaturate the soil, damage the root system, and results in plant diseases. Further, water pooling within container 105 can support fungal and bacterial growth within environment 101. Therefore, preventing flooding and water buildup within environment 101 by system 100 is important for the health of plant(s) 102. In some embodiments, irrigation subsystem 150 comprises a plurality of flood controls to mitigate the risk of flooding environment 101 with water or other irrigation fluid. In some embodiments, irrigation subsystem 150 comprises a dehumidifier device with a sensor, such as a float switch, that activates either an outlet valve to open or a third pump 160 to empty the water reservoir within the dehumidifier device. In some embodiments, irrigation subsystem 150 comprises a flood sensor to shut off water supply within the system. Additionally, plant container 105 may include integrated features to prevent overwatering, such as drainage holes positioned to allow water to exit plant container 105 after it reaches a predetermined volume. A more detailed depiction of one example embodiment of plant container 105 is provided in reference to FIG. 3 below.

FIG. 3 is a front view of an embodiment of a sub-irrigated plant container and soil moisture probe. FIG. 3 shows plant container 105 configured as a sub-irrigated planter. A sub-irrigated planter is an example of plant container 105 wherein water is added to a reservoir at the bottom of container 105 as described below. Water moved from this reservoir upwards into the soil through one or a plurality of wicks 180. Wick 180 is formed from a material having a structure through which water or other fluid may move upwards against gravity by wicking or capillary action. In some embodiments, wick 180 comprises a ½ inch diameter length of nylon rope positioned proximate to each of four corners of container 105, for example. Other such materials include woven cotton fabric, cotton felt, other natural or synthetic textiles, a length of sisal rope or other fibrous rope or cord made from natural or synthetic fibers, and the like. This allows water to move upward through the soil by wicking and capillary action. Advantageously, sub-irrigated planters allow water concentration to be more evenly distributed than in a top-watered planter. Sub-irrigated planters can decrease over and underwatering and adverse plant health associated with those conditions.

In some embodiments, sub-irrigated planter 105 comprises side walls, a base, and three zones disposed therein. For example, the top zone of sub-irrigated planter 105 is a soil area 103 where soil or other root-supporting material is positioned. Soil area 103 typically contains a portion of plant 102, such as the roots and part of the stem of plant 102. Below soil area 103, a middle zone of sub-irrigated planter 105 forms an air space 104. Space 104 primarily contains air or, in some embodiments, can contain a highly porous substrate material that includes air, such as dried sphagnum or other moss. In some embodiments, an additional sheet of porous material separates soil area 103 from air space 104, such as a perforated sheet, screen, mesh or the like. The porous material layer retains soil within soil area 103 while allowing air and water to permeate therethrough. The third zone of sub-irrigated planter 105 is a water area 106. Area 106 stores water within sub-irrigated planter 105. Water may fill completely or partially fill water area 106.

In some embodiments, roots of plant 102 are confined within soil area 103. In some embodiments, roots of plant 102 grow or otherwise extend from soil area 103 through air space 104 and into water area 106. Whether the roots are confined within soil area 103 depends on whether a material forming a barrier between soil area 103 and air space 104 has openings large enough to allow root fibers to grow therethrough but still sufficiently small to retain the soil or other growth medium. One example is cotton gauze, although this is but a single, non-limiting example. Thin open-weave textile barriers formed from synthetic fibers are also used, in some embodiments.

In some embodiments, soil moisture probe 166 is disposed within sub-irrigated planter 105. A sub-irrigated planter (“SIP”) sensor 167 is a form of sensor 112 that detects a fluid level within sub-irrigated planter 105, distinguished from moisture probe 166 that detects soil moisture content of container 105 regardless of whether container 105 is a sub-irrigated container. SIP. A float sensor, an optical sensor, or other commercially available sensor known in the art to detect a fluid level is used as SIP sensor 167, in some embodiments.

In some embodiments, SIP sensor 167 is a specially designed sensor configured to modulate a water or other fluid level in a bottom of container 105 as part of a sub-irrigation subsystem. In some embodiments, SIP sensor 167 comprises a top inner tube 168 and a bottom outer tube 170 nested over inner tube 168, as shown in FIG. 3. In some embodiments, outer tube 170 and inner tube 168 are coaxial with and at least partially overlapping the top inner tube. This coaxial orientation is not a requirement, however. Top inner tube 168 comprises two separated electrically conductive top probes 169, positioned as shown in FIG. 3. Bottom outer tube 170 comprises two separated electrically conductive electrically conductive bottom probes 171, also positioned as shown in FIG. 3. Probes 168 and 169 are formed from a conductive material resistant to corrosion in a moist environment, such as copper, for example. A lower end of outer tube 179 is mounted in a fixed position, in some embodiments, within water area 106 near a bottom of plant container 105. In a dry condition whereunder a water level from within water area 106 is below the lower ends of bottom probes 171, an open-circuit voltage measured between bottom probes 171 approximates a source voltage between bottom probes 171. In a wet condition whereunder the water level within water area 106 is above the lower ends of bottom probes 171, i.e., at least a portion of both probes 171 is submerged, the voltage between bottom probes 171 drops substantially depending on the purity/electrolyte composition of the water. If pure distilled water or other electrically nonconductive fluid is submerging the portion of both probes 171, the open-circuit approximates the open circuit (source) voltage, however this is not a factor in operation of SIP sensor 167 because water used in system 100 contains minerals, ions, and impurities in solution making the water electrically conductive.

In some embodiments, a voltage difference between a state wherein probes 171 are submerged (closed circuit) and non-submerged (open circuit) can be tuned by placement of a resistor in series with one or both probes 171. Choosing a resistive value for the one or more resistors allow tuning to maximize the difference between the open circuit and closed circuit voltages, therein affecting the sensitivity of SIP sensor 167 to detect the presence or absence of water electrically coupling probes 171. Similarly, a resistor in series with one or both probes 169 is also used, in some embodiments. In some embodiments, the resistor is a tunable variable-resistance resistor. In some embodiments, the resistor is a fixed-resistance resistor.

Inner tube 168 is similarly configured to detect when water or other conductive fluid contacts both of two top probes 169. For example, whereunder the interface between water area 106 and air space 104 is below a lower end of inner tube 168, a voltage across probes 169 approximates a power source voltage and whereunder the interface between water area 106 and air space 104 is above the lower end of inner tube 168, thus contacting probes 169 and allowing current flow therebetween, the voltage drops to a level based only on an internal electrical resistance of the circuit. Sensor 167 is coupled to an effector 113, such as a pump 160 or valve 162, to either cause the water to flow or stop flowing into certain embodiments of container 105, including those configured as a sub-irrigation system as described herein. In some embodiments, a voltage drop across probes 169 of top inner tube 168 causes effector 113 to interrupt power to pump 160 or close valve 162 causing cessation of flow of water into container 105. In some embodiments, a voltage jump across probes 171 of lower outer tube 170 causes effector 113 to deliver power to pump 160 or open valve 162, causing initiation of flow of water into container 105.

In some embodiments, a height of top inner tube 168 within container 105 is adjustable and a securing means 174 allows the user to fix an adjustable vertical position of tube 168, such as by tightening a set screw, engaging a latch, or engaging other fixation means 174, for example. This element allows the user to “tune” sensor 167 with respect to maintaining a quantity of water or other fluid within subirrigation embodiments of container 105.

In some embodiments, SIP sensor 167 is customized to complement a sub-irrigated planter 105. For example, top inner tube 168 and bottom outer tube 170 have lengths matching the height of a soil level within planter 105. In this example, a top inner tube 168 is moveably coupled to bottom outer tube 170. Top inner tube 168 is adjusted vertically by the user to a desired depth in the soil. The top inner tube 168 is then mechanically fixed within bottom outer tube 170 by a securing means 174, such as one or more set screws, rods, or a similar conventional fastener. In line with previously described sensors 112 and soil moisture probe 166, the electrical output of SIP sensor 167 changes with changing water conditions. In some embodiments, SIP sensor 167 positioned within water area 106 is electronically coupled with master controller 120 through a dedicated electronics module 111 to monitor fluid levels within the sub-irrigated planter 105. Master controller 120 receives water level data from SIP sensor 167 to activate and transmits an effector signal 121 to deactivate irrigation subsystem 150 causing initiation or cessation of water flow to sub-irrigated planter 105.

FIG. 4 is a schematic view of an embodiment of master controller 120. Master controller 120 comprises hardware and software elements that monitor and control conditions within environment 101 through one or more parameter controls 110. Specifically, master controller 120 comprises board 123 for mechanically affixing and electrically coupling individual electronic components. For example, in some embodiments, master controller 120 includes a single-board computer (“SBC”) 134. SBC 134 is a device developed and specifically customized for automated garden system 100, in some embodiments. In some embodiments, SBC 134 comprises a commercially available single-board computer such as an Arduino, Raspberry Pi, or ODROID device.

In some embodiments, master controller 120 further comprises a memory 126. Memory 126 is separate from SBC 134, in some embodiments, such as a secure digital (“SD”) card. In some embodiments, memory 126 is integrated with SBC 134. Memory 126 stores software coding for various functionalities of system 100, such as an operating system software and readable memory containing setpoints for each parameter control 110, for example. Memory 126 includes any combination of random access (cache) memory (“RAM”) and non-RAM “main” memory. In some embodiments, automated garden system 100 and environment 101 data are stored on memory 126. Master controller 120 may be configured with partitions providing environmental controls and other systems, such as irrigation and light delivery, for example, with distinct monitoring and maintenance systems.

In some embodiments, master controller 120 comprises a programable logic controller 132. Programable logic controller (“PLC”) 132 may comprise a variety of available programmable logic controllers known in the art, such as single box PLCs or modular PLCs. In embodiments wherein PLC 132 is a modular PLC, PLC 132 comprises multiple racks, a power supply, processors and communication interfaces. A microprocessor administers multiple racks, each of which may correspond to a different parameter control 110, in some embodiments. The microprocessor may be a commercially available microprocessor widely used in consumer electronic device control systems and known in the art.

In some embodiments, electronics module 111 further comprises one or more relays 138. Relay 138 is configured by operating parameters input by the user to master controller 120 and received by electronics module 111 for activating or de-activating a power supply to effector 115. For example, where effector 115 is a pump, the relay opens or closes a separate higher-amperage electrical circuit powering the pump. In some embodiments, relay 138 is a condenser switch. Within system 100, one or more relays 138 are activated or deactivated by parameter controls 110. For example, one or more relays 138 control the on/off positions of one or more corresponding water pumps 160 of irrigation subsystem 150. Relay 138 may be provided in wired or wireless configurations to best suit a particular embodiment of system 100 and its subcomponents.

In some embodiments, master controller 120 comprises a network switch 136. Where present, network switch 136 facilitates communication between master controller 120 and other elements such as components of system 100 or communication means such as Wi-Fi, Bluetooth and/or wired cloud computing services. In some embodiments, master controller 120 comprises multiple network switches 136 to facilitate multiple or back-up means of network communication.

Master controller 120 further comprises a power supply. The power supply may be a standard AC outlet, a battery, or both. In some embodiments, the battery is optionally connected to a solar photovoltaic panel or other non-AC charging means. In some embodiments, subcomponents of master controller 120 are housed within a waterproof casing to protect the electronics mounted therein from water damage.

According to some embodiments, master controller 120 comprises an input/output communications 125 configured to electronically couple electronics module(s) 111 to master controller 120. Input/output communications 125 may comprise wired or wireless communication coupling means so that various elements of parameter control 110 can exchange information with master controller 120. In some embodiments, such communicative coupling means are hard-wired comprising some or all of wires, input pins, connectors, wire harnesses, and plugs in any combination to couple one or more parameter controls 110, such as irrigation subsystem 150 and others, with master controller 120. In some embodiments, such communicative coupling means are wireless, utilizing Bluetooth, for example.

Master controller 120 further comprises a user interface 127 having an interactive display. In some embodiments, user interface 127 is an interactive touchscreen device having a display 128. User interface 127 is configured to access memory 126 to allow the user to read outputs from sensor 112, review data from effector 115 and subsystems such as irrigation subsystem 150, and adjust various operating setpoints of parameter control 110 to optimize plant health and growth. In some embodiments, user interface 127 is a smartphone, a laptop computer, a tablet computer, or other computing device communicatively coupled to master controller 120 with any wired or wireless coupling means known in the art. User interface 127 enables the user to remotely monitor and change settings of master controller 120 over the Internet.

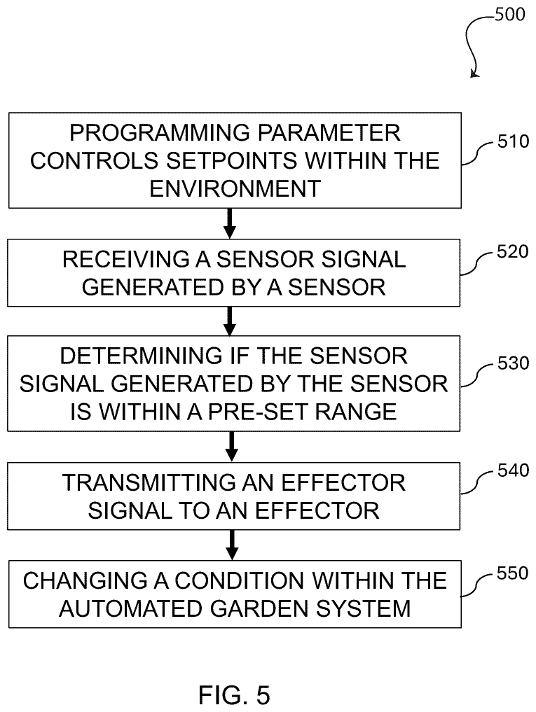

FIG. 5 is a diagram illustrating steps of a method 500 of controlling automated garden system 100. Method 500 comprises a programming step 510, a receiving step 520, a determining step 530, a transmitting step 540, and a changing step 550, in some embodiments. As described herein above, automated garden system 100 comprises a plant container disposed within an environment. An automated gardening system further comprises one or more parameter controls, each having an electronics module, a sensor, an effector 115, and a switch functionally coupled to the sensor. The parameter control is configured to affect a condition of the environment from a group of conditions. For example, the group of conditions may include temperature, relative humidity, light level, light spectrum, moisture level, level or volatile materials or other pollutants, and carbon dioxide concentration. The automated system may also comprise a master controller communicatively coupled to the one or more parameter controls for receiving data from and sending settings to the parameter controls according to a computer program with an algorithm residing on a memory of the master controller. In some embodiments, an effector signal travels from each sensor to the electronics module of the one or more parameter controls.

In some embodiments, programming step 510 comprises programming parameter controls setpoints within environment 101. Programming step 510 includes user input of desired settings to the control program residing on a memory within a master controller to maintain the condition controlled by said parameter control 110 within certain setpoints. These setpoints are determined by a user and monitored by sensors 112.

Receiving step 520, in some embodiments, comprises receiving a sensor signal 140 generated by a sensor. The sensor signal travels from the sensor to the electronics module. In some embodiments, the electronics module receives the sensor signal and transmits data from the sensor signal to the master controller.

Determining step 530, in some embodiments, comprises determining if the sensor signal is within a preset range. The electronics module determines whether the sensor signal is within, above, or below the preset range according to settings received from the master controller.

Transmitting step 540, in some embodiments, comprises the electronics module transmitting an effector signal to an effector configured to change the environmental condition. If the sensor signal is within the preset range, the electronics module send no signal to the effector. If the sensor signal is above or below the preset range, the electronics module activates the effector.

Changing step 550 comprises changing a condition within environment 110. Wherein the effector receives the effector signal from the electronics module, the effector is “activated.” In some embodiments, the effector remains activated for a length of time. In some embodiments, the length of time is preset by user input to a user interface of the master controller. In some embodiments, the effector remains activated until the sensor signal returns to a level within the preset range.

Depending on the embodiment, steps of method 500 results in regulation of any one or combination of environmental conditions affecting plant health, such as air temperature, relative humidity, light level, light spectrum, moisture level, pollutant level, and carbon dioxide concentration, for example.

A user may access memory 126 of master controller 120 and retrieve historical data relating to actions of automated garden system 100. The user may elect to input instructions or change settings through application software residing on memory 126 of master controller 120 wherein parameter control 110 regulates a condition of environment 101. In some embodiments, the user can remotely access user interface 127 of master controller 120, modify a software program stored on master controller 120, and execute the adjusted program. For example, in some embodiments, the user observing a monitoring camera feed may note that plant 102 has grown substantially, is flowering, is bearing fruit, or has otherwise reached a new development stage. The user may decide to cause changes to one or more individual environmental conditions by adjusting setpoint values of parameter controls 110, such as irrigation subsystem 150 or others, to best suit the new phase of plant development. The user may, for example, increase carbon dioxide concentration or adjust the light spectrum from blue to red light to encourage fruit development. They may adjust the acceptable water content within plant container 105 or change the maximum allowable concentration of air pollutant levels during a pollination phase of plant 102. Generally, the user is able to make changes to parameter control 110 settings through software applications within master controller 120 to regulate conditions within environment 101.

In some embodiments, the user accesses user interface 127 through a remote wireless connection means utilizing a cellular or other wireless communications network. According to some embodiments, method 500 further comprises adjusting a plurality of inputs, output, and settings of master controller 120 to change a corresponding plurality of conditions of the environment.

The present disclosure provides devices, systems, and methods of automated garden system 100. The disclosed devices, systems, and methods are fully automated and may be monitored and adjusted remotely, providing advantages over existing systems. These advantages allow users, such as gardeners, to monitor and care for their gardens from great distances. The systems and methods of the present disclosure further enable users to adjust conditions within environment 100 to optimize plant health and growth that are tailored to the changing plant needs at different stages of plant development.

The embodiments and examples set forth herein were presented in order to best explain the present invention and its practical application, and to thereby enable those of ordinary skill in the art to make and use the invention. However, those of ordinary skill in the art will recognize that the foregoing description and examples have been presented for the purpose of illustration and example. The description as set forth is not intended to be exhaustive or to limit the invention to the precise form disclosed. Many modifications and variations are possible, in light of the teachings herein above.

1. An automated gardening system comprising:
a plant container disposed in an environment, wherein the plant container is a sub-irrigated planter having a soil area, a water area containing water, and an air space disposed between the soil area and the water area;
a parameter control having a sensor, an electronics module functionally coupled to the sensor, and an effector disposed in the environment and functionally coupled to the electronics module,
wherein the parameter control is configured to modulate a condition of the environment from the group of conditions consisting of a temperature, a relative humidity, a light level, a light spectrum, a moisture level, an odor, and a carbon dioxide concentration;
wherein the condition of the environment is sensed by the sensor and changed by the effector;
wherein the effector comprises a valve mechanism disposed in a tube fluidly interposed between a feeder tank and the plant container to modulate a fluid level within a water area of the plant container; and
a master controller communicatively coupled to the parameter control and having programmable logic controller, a memory, and a user interface, wherein the master controller comprises a network switch configured to provide communication among subsystems and the master controller.

2. The system of claim 1, wherein the master controller comprises a network switch disposed within a housing of the master controller and configured to provide wired Ethernet communication among a plurality of parameter controls and the master controller.

3. The system of claim 1, wherein the effector comprises an electrical relay disposed in an electronics module and configured to switch a higher-voltage load in response to a low-voltage effector signal from the electronics module.

4. The system of claim 3, wherein the relay is a solid-state relay configured as a zero-crossing AC solid-state relay to switch an AC load of the effector.

5. The system of claim 1, wherein the plant container is a sub-irrigated planter.

6. The system of claim 1, wherein the parameter control is an irrigation subsystem comprising:
a feeder tank;
a flow control device functionally coupled to the electronics module;
a tube fluidly coupling the feeder tank to the plant container; and
a moisture sensor disposed within the plant container and functionally coupled to the electronic module, wherein the flow control device comprises an automated, magnetically controlled ball valve.

7. The system of claim 6, wherein the irrigation control system comprises a pump configured to move the fluid through the plurality of tubes in response to a signal from a float switch.

8. An automated gardening system comprising:
a feeder tank raised in elevation above the plant container to provide gravity-fed flow;
a plant container disposed in an environment and having zones therein including
a soil area, a water area containing water, and an air space disposed between the soil area and the water area, wherein a wick extends from the water area into the soil area to move water upward by capillary action;
a tube fluidly interposed between the feeder tank and the plant container, wherein the tube comprises a plurality of tubes fluidly coupling a fluid reservoir to a plurality of plant containers;
a parameter control comprising a sensor, an effector, and an electronics module functionally coupled to the sensor and the effector, wherein the sensor is a fluid level sensor positioned in the water area, the effector is a valve mechanism disposed in the tube;
wherein the parameter control is configured to modulate a fluid level within the water area; and
a master controller communicatively coupled to the parameter control and having programmable logic controller, a memory, and a user interface wherein the master controller comprises a network switch.

9. The system of claim 8, wherein the fluid level sensor disposed within the water area comprises a top inner tube and a bottom outer tube at least partially overlapping the top inner tube;
wherein the top inner tube comprises two electrically conductive probes, the bottom outer tube comprises two electrically conductive probes, and the top inner tube is moveably coupled to the bottom outer tube by a securing means configured to fix an adjustable vertical position of the top inner tube relative to the bottom outer tube.
